(19) United States
(12) Patent Application Publication
(10) Pub. No.: US 2023/0184931 A1
(43) Pub. Date: Jun. 15, 2023

(54) RADAR AND LIDAR BASED DRIVING TECHNOLOGY

(71) Applicant: TuSimple, Inc., San Diego, CA (US)

(72) Inventors: Panqu WANG, San Diego, CA (US); Lingting GE, San Diego, CA (US)

(21) Appl. No.: 17/987,200

(22) Filed: Nov. 15, 2022

Related U.S. Application Data
(60) Provisional application No. 63/289,973, filed on Dec. 15, 2021.

(51) Int. Cl. G01S 13/931; G01S 13/89; G01S 17/931; G01S 17/89; G01S 13/86

(52) U.S. Cl. CPC G01S 13/931; G01S 13/89; G01S 17/931; G01S 17/89; G01S 13/865

(57) ABSTRACT

Vehicles can include systems and apparatus for performing signal processing on sensor data from radar(s) and LiDAR(s) located on the vehicles. A method includes obtaining and filtering radar point cloud data of an area in an environment in which a vehicle is operating on a road to obtain filtered radar point cloud data; obtaining a light detection and ranging point cloud data of at least some of the area, where the light detection and ranging point cloud data include information about a bounding box that surrounds an object on the road; determining a set of radar point cloud data that are associated with the bounding box that surrounds the object; and causing the vehicle to operate based on one or more characteristics of the object determined from the set of radar point cloud data.

### CROSS-REFERENCE TO RELATED APPLICATIONS

This document claims priority to and benefits of U.S. Patent Application No. 63/289,973, filed on Dec. 15, 2021. The aforementioned application of which is incorporated by reference in its entirety.

### TECHNICAL FIELD

This document describes techniques to perform signal processing on sensor data provided by one or more radars and one or more Light Detection and Ranging (LiDAR) devices located on or in a vehicle for autonomous driving operations.

### BACKGROUND

A vehicle may include sensors such as cameras attached to the vehicle for several purposes. For example, cameras may be attached to a roof of the vehicle for security purposes, for driving aid, or for facilitating autonomous driving. The sensors mounted on a vehicle can obtain sensor data (e.g., images) of one or more areas surrounding the vehicle. The sensor data can be processed to obtain information about the road or about the objects surrounding the vehicle. For example, images obtained by a camera can be analyzed to determine distances of objects surrounding the autonomous vehicle so that the autonomous vehicle can be safely maneuvered around the objects.

### SUMMARY

Autonomous driving technology can enable a vehicle to perform autonomous driving operations by determining characteristics of a road (e.g., stop sign, curvature or location of a lane) and/or characteristics of objects (e.g., pedestrians, vehicles) located on the road. One or more computers located in the vehicle can determine the characteristics of the road and/or objects on the road by performing signal processing on sensor data provided by sensors located on or in the vehicle, where the sensors may include cameras, Light Detection and Ranging (LiDAR), and/or radar. This patent document describes techniques for performing signal processing on sensor data from at least two sensors (e.g., a radar and a LiDAR) to obtain information about objects on the road so that the vehicle can perform autonomous driving operations.

An example method of vehicle operation includes obtaining radar point cloud data of an area in an environment in which a vehicle is operating on a road, wherein the radar point cloud data is obtained or derived from a scan of the area by a radar located on the vehicle; obtaining filtered radar point cloud data by filtering the radar point cloud data using a set of one or more rules; obtaining a light detection and ranging point cloud data of at least some of the area scanned by a light detection and ranging sensor located on the vehicle, wherein the light detection and ranging point cloud data include information about a bounding box that surrounds an object on the road; determining a set of radar point cloud data that are associated with the bounding box that surrounds the object, wherein the set of radar point cloud data is determined from the filtered radar point cloud data that is combined with the light detection and ranging point cloud data onto a same coordinate system; and causing the vehicle to operate based on one or more characteristics of the object determined from the set of radar point cloud data. Operations 402 to 410 can be performed by the sensor data processing module as explained in this patent document.

In some embodiments, the set of one or more rules includes a map based rule in which the filtered radar point cloud data is obtained by removing at least some radar point cloud data from the radar point cloud data in response to determining that the at least some radar point cloud data is not related to a road where the vehicle is operated. In some embodiments, the radar point cloud data is located on another road that is opposite to the road on which the vehicle is operated. In some embodiments, the set of one or more rules includes a range related rule in which the filtered of radar point cloud data is obtained by removing at least some radar point cloud data from the radar point cloud data in response to determining that the at least some radar point cloud data is located beyond a predetermined range of a location of the vehicle.

In some embodiments, the predetermined range is associated with the radar or is associated with a set of radars on the vehicle that includes the radar. In some embodiments, the set of one or more rules includes a velocity related rule in which the filtered radar point cloud data is obtained by removing at least some radar point cloud data from the radar point cloud data in response to determining that the at least some radar point cloud data is associated with one or more velocities that are outside of a predetermined range of velocities. In some embodiments, the one or more characteristics include a location and/or velocity of the object.

In some embodiments, the determining the set of radar point cloud data includes performing a data clustering technique using the filtered radar point cloud data that is combined with the light detection and ranging point cloud data onto the same coordinate system and the information about a position of the bounding box that surrounds the object, wherein the set of radar point cloud data includes information that describes the bounding box of the object. In some embodiments, the data clustering technique is performed by removing at least some radar point cloud data from the second set of radar that is combined with the light detection and ranging point cloud data in response to a determination that the at least some radar point cloud data is not within or not on or not within a certain region or distance of the bounding box of the object. In some embodiments, the data clustering technique includes a density-based spatial clustering of applications with noise technique. In some embodiments, the data clustering technique is performed by removing at least some radar point cloud data from the filtered radar point cloud data that is combined with the light detection and ranging point cloud data in response to a determination that the at least some radar point cloud data have one or more velocities that are outside of a statistical range of velocities.

In some embodiments, the causing the vehicle to operate based on the one or more characteristics of the object includes sending instructions to a steering system and/or to a brake system to steer and/or to apply brakes. In some embodiments, the causing the vehicle to operate based on the one or more characteristics of the object includes sending instructions that cause the vehicle to steer and/or to apply brakes. In some embodiments, the vehicle includes a plurality of radars that include the radar and a plurality of light detection and ranging sensors that include the light detection and ranging sensor, wherein at least one radar is located toward a front of the vehicle, wherein at least one radar is located on each side of the vehicle, and wherein at least one radar is located towards a rear of the vehicle.

In some embodiments, the set of one or more rules includes a velocity related rule in which the filtered radar point cloud data is obtained by removing at least some radar point cloud data from the radar point cloud data in response to determining that the at least some radar point cloud data is associated with at least one object whose velocity indicates that the at least one object is traveling towards the vehicle. In some embodiments, the set of one or more rules includes a static point rule in which the second set of radar PCT is obtained by removing at least some radar point cloud data from the radar point cloud data in response to determining that the at least some radar point cloud data is associated with static points using a map and a location of the vehicle.

In some embodiments, the filtered radar point cloud data is combined with the light detection and ranging point cloud data onto the same coordinate system by: projecting the filtered radar point cloud data onto an inertial measurement unit coordinate system using first extrinsic parameters; and projecting the light detection and ranging point cloud data onto the IMU coordinate system using second extrinsic parameters. In some embodiments, the first extrinsic parameters include an inertial measurement unit-to-radar extrinsic parameters, and wherein the second extrinsic parameters include an internal measurement unit-to-light detection and ranging extrinsic parameters. In some embodiments, the radar point cloud data, the filtered radar point cloud data, and the set of radar point cloud data include location information and/or velocity information of one or more objects in the area, wherein the one or more objects comprises the object. In some embodiments, the one or more objects include one or more vehicles and/or one or more pedestrians. In some embodiments, the vehicle includes an autonomous vehicle.

In another exemplary aspect, the above-described methods are embodied in the form of processor-executable code and stored in a non-transitory computer-readable storage medium. The non-transitory computer readable storage includes code that when executed by a processor, causes the processor to implement the methods described in the embodiments.

In yet another exemplary embodiment, a device that is configured or operable to perform the above-described methods is disclosed.

In yet another exemplary embodiment, a system is disclosed for vehicle operation, where the system includes a computer or a server that comprises at least one processor and at least one memory including computer program code which, when executed by the at least one processor, cause the computer to at least perform the above-described methods.

The above and other aspects and their implementations are described in greater detail in the drawings, the descriptions, and the claims.

### BRIEF DESCRIPTION OF THE DRAWING

FIG. 1 shows a block diagram of an example vehicle ecosystem for autonomous driving radar technology.

FIG. 2 shows a top view of an autonomous vehicle that includes a plurality of radars.

FIG. 3 shows a flowchart of an example signal processing technique to process sensor data obtained by a radar and a LiDAR.

FIG. 4 shows another flowchart of an example signal processing technique performed on radar point cloud data and LiDAR point cloud data for driving operations.

### DETAILED DESCRIPTION

An autonomous vehicle may include sensors such as cameras, Light Detection and Ranging (LiDAR), and/or a radar mounted on the autonomous vehicle to obtain sensor data (e.g., point cloud data from LiDAR and/or point cloud data from radar) of one or more areas surrounding the autonomous vehicle. The sensor data can be obtained and analyzed by one or more computers on-board the autonomous vehicle to determine characteristics of objects (e.g., vehicles or pedestrians) surrounding the autonomous vehicle on the road. The characteristics of the object may include a distance of the object from the autonomous vehicle and/or speed of the object. The computer(s) located in the autonomous vehicle can perform signal processing techniques on sensor data obtained from LiDAR and radar so that the computer(s) can precisely or accurately detect an object and determine its characteristics. Section I of this patent document describes an example vehicle ecosystem in which the example signal processing techniques described in Section II of this patent document can be performed. In Section II, this patent document describes example signal processing techniques for effectively combining and analyzing sensor data received from at least two sensors (e.g., radar and LiDAR) so that the signal processing techniques can provide characteristics of objects on the road in some embodiments.

### I. Example Vehicle Ecosystem for Autonomous Driving Radar Technology

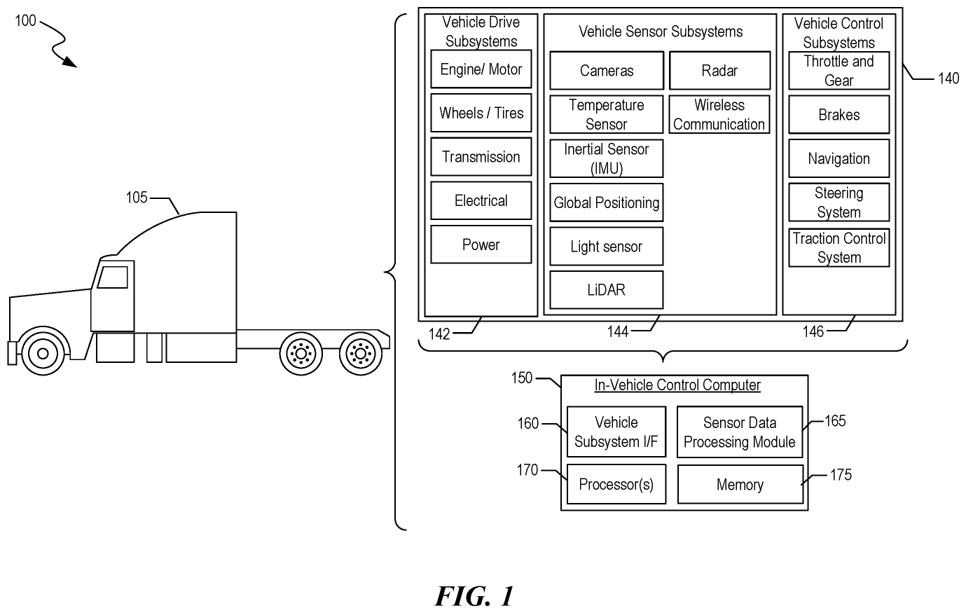

FIG. 1 shows a block diagram of an example vehicle ecosystem 100 for autonomous driving radar technology. The vehicle ecosystem 100 may include an in-vehicle control computer 150 is located in the autonomous vehicle 105. The sensor data processing module 165 of the in-vehicle control computer 150 can perform signal processing techniques on sensor data received from radar and LiDAR so that the signal processing techniques can provide characteristics of objects located on the road where the autonomous vehicle 105 is operated in some embodiments. The sensor data processing module 165 can use at least the information about the characteristics of one or more objects to send instructions to one or more devices (e.g., motor in the steering system or brakes) in the autonomous vehicle 105 to steer and/or apply brakes.

As shown in FIG. 1, the autonomous vehicle 105 may be a semi-trailer truck. The vehicle ecosystem 100 may include several systems and components that can generate and/or deliver one or more sources of information/data and related services to the in-vehicle control computer 150 that may be located in an autonomous vehicle 105. The in-vehicle control computer 150 can be in data communication with a plurality of vehicle subsystems 140, all of which can be resident in the autonomous vehicle 105. The in-vehicle computer 150 and the plurality of vehicle subsystems 140 can be referred to as autonomous driving system (ADS). A vehicle subsystem interface 160 is provided to facilitate data communication between the in-vehicle control computer 150 and the plurality of vehicle subsystems 140. In some embodiments, the vehicle subsystem interface 160 can include a controller area network (CAN) controller to communicate with devices in the vehicle subsystems 140.

The autonomous vehicle 105 may include various vehicle subsystems that support the operation of autonomous vehicle 105. The vehicle subsystems may include a vehicle drive subsystem 142, a vehicle sensor subsystem 144, and/or a vehicle control subsystem 146. The components or devices of the vehicle drive subsystem 142, the vehicle sensor subsystem 144, and the vehicle control subsystem 146 as shown as examples. In some embodiment, additional components or devices can be added to the various subsystems. Alternatively, in some embodiments, one or more components or devices can be removed from the various subsystems. The vehicle drive subsystem 142 may include components operable to provide powered motion for the autonomous vehicle 105. In an example embodiment, the vehicle drive subsystem 142 may include an engine or motor, wheels/tires, a transmission, an electrical subsystem, and a power source.

The vehicle sensor subsystem 144 may include a number of sensors configured to sense information about an environment in which the autonomous vehicle 105 is operating or a condition of the autonomous vehicle 105. The vehicle sensor subsystem 144 may include one or more cameras or image capture devices, one or more temperature sensors, an inertial measurement unit (IMU), a Global Positioning System (GPS) device, one or more LiDARs, a plurality of radars, and/or a wireless communication unit (e.g., a cellular communication transceiver). The vehicle sensor subsystem 144 may also include sensors configured to monitor internal systems of the autonomous vehicle 105 (e.g., an O₂ monitor, a fuel gauge, an engine oil temperature, etc.). In some embodiments, the vehicle sensor subsystem 144 may include sensors in addition to the sensors shown in FIG. 1.

The IMU may include any combination of sensors (e.g., accelerometers and gyroscopes) configured to sense position and orientation changes of the autonomous vehicle 105 based on inertial acceleration. The GPS device may be any sensor configured to estimate a geographic location of the autonomous vehicle 105. For this purpose, the GPS device may include a receiver/transmitter operable to provide information regarding the position of the autonomous vehicle 105 with respect to the Earth. Each of the radars may represent a system that utilizes radio signals to sense objects within the environment in which the autonomous vehicle 105 is operating. In some embodiments, in addition to sensing the objects, the radars may additionally be configured to sense the speed and the heading of the objects proximate to the autonomous vehicle 105. The laser range finder or LiDAR may be any sensor configured to sense objects in the environment in which the autonomous vehicle 105 is located using lasers. The cameras may include one or more cameras configured to capture a plurality of images of the environment of the autonomous vehicle 105. The cameras may be still image cameras or motion video cameras.

The vehicle control subsystem 146 may be configured to control operation of the autonomous vehicle 105 and its components. Accordingly, the vehicle control subsystem 146 may include various elements such as a throttle and gear, a brake unit, a navigation unit, a steering system and/or a traction control system. The throttle may be configured to control, for instance, the operating speed of the engine and, in turn, control the speed of the autonomous vehicle 105. The gear may be configured to control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more predetermined maps so as to determine the driving path for the autonomous vehicle 105. The steering system may represent any combination of mechanisms that may be operable to adjust the heading of autonomous vehicle 105 in an autonomous mode or in a driver-controlled mode.

In FIG. 1, the vehicle control subsystem 146 may also include a traction control system (TCS). The TCS may represent a control system configured to prevent the autonomous vehicle 105 from swerving or losing control while on the road. For example, TCS may obtain signals from the IMU and the engine torque value to determine whether it should intervene and send instruction to one or more brakes on the autonomous vehicle 105 to mitigate the autonomous vehicle 105 swerving. TCS is an active vehicle safety feature designed to help vehicles make effective use of traction available on the road, for example, when accelerating on low-friction road surfaces. When a vehicle without TCS attempts to accelerate on a slippery surface like ice, snow, or loose gravel, the wheels can slip and can cause a dangerous driving situation. TCS may also be referred to as electronic stability control (ESC) system.

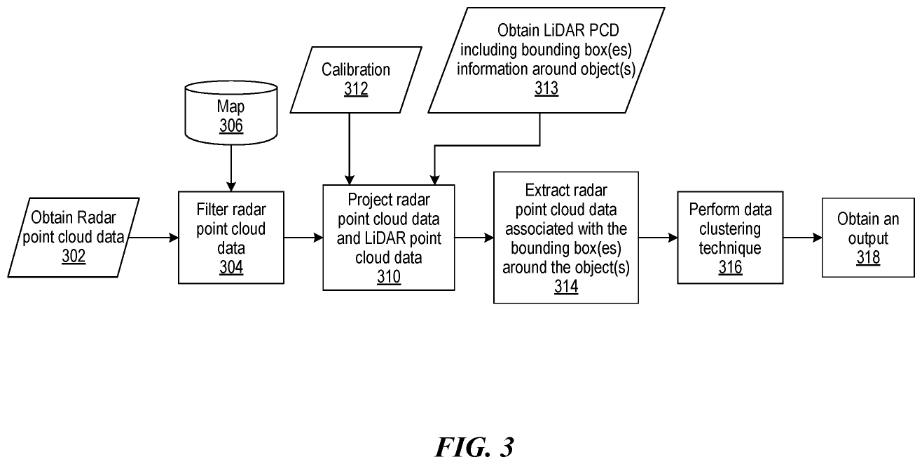

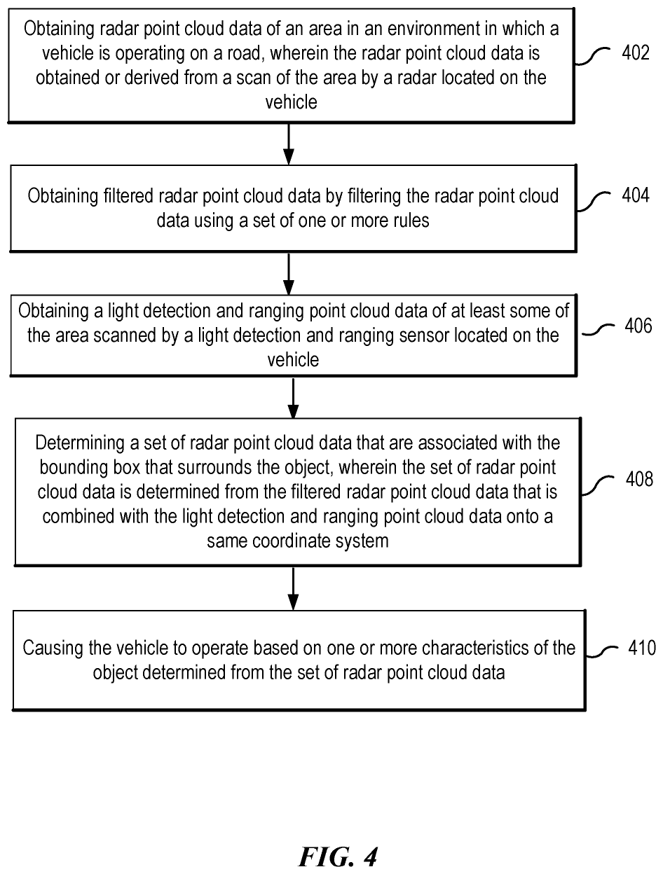

Many or all of the functions of the autonomous vehicle 105 can be controlled by the in-vehicle control computer 150. The in-vehicle control computer 150 may include at least one processor 170 (which can include at least one microprocessor) that executes processing instructions stored in a non-transitory computer readable medium, such as the memory 175. The in-vehicle control computer 150 may also represent a plurality of computing devices that may serve to control individual components or subsystems of the autonomous vehicle 105 in a distributed fashion. In some embodiments, the memory 175 may contain processing instructions (e.g., program logic) executable by the processor 170 to perform various methods and/or functions of the autonomous vehicle 105, including those described for the sensor data processing module 165 as explained in this patent document. For example, the processor 170 of the in-vehicle control computer 150 and may perform operations described in this patent document in, for example, FIGS. 3 and 4.

The memory 175 may contain additional instructions as well, including instructions to transmit data to, receive data from, interact with, or control one or more of the vehicle drive subsystem 142, the vehicle sensor subsystem 144, and the vehicle control subsystem 146. The in-vehicle control computer 150 may control the function of the autonomous vehicle 105 based on inputs received from various vehicle subsystems (e.g., the vehicle drive subsystem 142, the vehicle sensor subsystem 144, and the vehicle control subsystem 146).

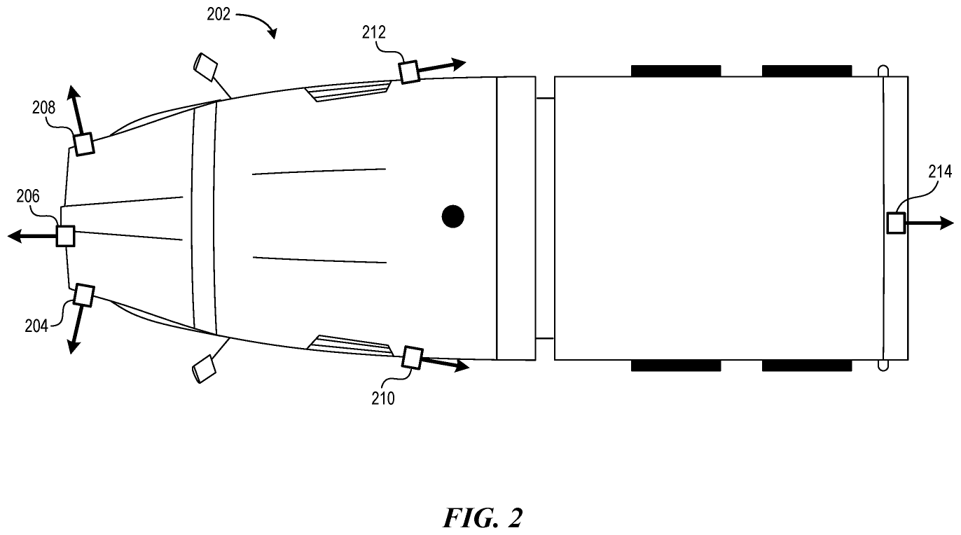

FIG. 2 shows a top view of an autonomous vehicle 202 that may include a plurality of radars 204 to 214. The locations of the plurality of radars 204 to 214 are exemplary. As shown in FIG. 2, the autonomous vehicle 202 may include a tractor portion of a semi-trailer truck. radars 204 to 208 may be coupled to a front bumper of the autonomous vehicle 202, radars 210 to 212 may be coupled to the side of the autonomous vehicle 202, and radar 214 may be coupled to a rear bumper of the autonomous vehicle 202. The plurality of radars 204 to 214 may be located around the autonomous vehicle 202 so that the radars can obtain sensor data from several areas in front of, next to, and/or behind the autonomous vehicle 202. For example, radar 206 can scan and obtain sensor data of an area that is in front of the autonomous vehicle 202, radars 204 and 208 can respectively scan and obtain sensor data of areas to the front left and front right of the autonomous vehicle 202, radars 210 and 212 can respectively scan and obtain sensor data of areas to the rear left and rear right of the autonomous vehicle 202, and radar 214 can scan and obtain sensor data of another area that to the rear of the autonomous vehicle 202. The plurality of radars 204 to 214 is communicably coupled to the in-vehicle control computer (shown as 150 in FIG. 1). The sensor data obtained by the plurality of radars 204 to 214 are sent to the sensor data processing module 165 for signal processing as further described in Section II of this patent document.

In some embodiments where the autonomous vehicle 202 may include a semi-trailer truck, a trailer unit may be coupled to the tractor unit of the semi-trailer truck. In such embodiments, the radar 214 located on a rear portion of the tractor unit (e.g., as shown in FIG. 2) may be referred to as a tunnel radar at least because the radar signals transmitted and received by the radar 214 can pass through the underside of the trailer unit.

### II. Example Signal Processing Techniques for Autonomous Driving Radar Technology

FIG. 3 shows a flowchart of an example signal processing technique to process sensor data obtained by a radar and a LiDAR. Operations 302 to 318 can be performed by the sensor data processing module of the in-vehicle control computer located in a vehicle. At operation 302, the sensor data processing module may obtain radar point cloud data from a radar on the vehicle. The radar point cloud data may include position (or location) information and/or velocity information of one or more objects in an area that is scanned by the radar, where the area (e.g., front of the vehicle) may be a part of an environment where the vehicle is operated.

At operation 304, the sensor data processing module filters radar point cloud data using a set of one or more rules. In some embodiments, the sensor data processing module may filter radar point cloud data using a map based rule that uses a map 306 stored in the in-vehicle control computer. The map 306 stored in the in-vehicle control computer may include location information about the road where the vehicle is operated. For example, the map 306 may include information about the road/lane on which the vehicle is operating. In such embodiments, the sensor data processing module can filter the radar point cloud data to remove radar point cloud data that is not related to (or is not within a certain area/distance around) the road where the vehicle is operated. For example, the sensor data processing module can use the map 306 to filter the radar point cloud data to remove radar point cloud data about areas to left and right of the road. In some implementations, the sensor data processing module can use the map based rule along with the identity of the radar that sent the radar point cloud data at operation 302 to filter the radar point cloud data. For example, the sensor data processing module can determine that the radar point cloud data is obtained from a radar (e.g., 206 in FIG. 2) that is scanning an area in front of the vehicle and can remove the radar point cloud data about the areas to the left and right of the road based on (1) a determination that the radar that sent the point cloud is scanning an area to the front of the vehicle and (2) the information provided by the map 306 about the road where the vehicle is operating. In some embodiments, the sensor data processing module can filter the radar point cloud data to remove the radar point clouds that are not relevant to the driving behavior of the vehicle. For example, the sensor data processing module can remove the radar point cloud data associated with another lane or another road that are opposite to a lane or a road on which the vehicle is operating.

In some embodiments, the sensor data processing module may filter radar point cloud data using a range related rule. In such embodiments, the sensor data processing module can use a predetermined range value to remove information from the radar point cloud data obtained at operation 302. For example, the predetermined range value can enable the sensor data processing module to remove information from the radar point cloud data that is located in beyond the predetermined range value of a location of the vehicle (e.g., obtained from a GPS device in the vehicle) so that the sensor data processing module can beneficially lower the computational load on the in-vehicle control computer. In some embodiments, the predetermined range value can be separately assigned to each radar or to a group of one or more radars. For example, the radar 206 may be associated with a first predetermined range value and a group of radars 204 and 208 may be associated with a second predetermined range value, where the first predetermined range value may be greater than the second predetermined range value at least because the sensor data processing module can process more radar point cloud data from a region towards the front of the vehicle than towards the regions to the front left or front right of the vehicle.

In some embodiments, the sensor data processing module may filter radar point cloud data using a velocity related rule. Since the radar point cloud data may provide velocity information about one or more objects in the area scanned by a radar, the sensor data processing module can use a velocity related rule to remove information from the point cloud data about objects whose velocity is out of a predetermined range and/or whose velocity indicates that the object is traveling towards the vehicle (e.g., velocity of −60 mph). In one example, if a predetermined range is 15 mph to 100 mph, then the sensor data processing module can remove information associated with one or more objects whose velocity or velocities are between 0 mph and 15 mph (e.g., a person on a bicycle or a pedestrian) or greater than 100 mph (e.g., an object having a spurious velocity value).

At operation 304, the sensor data processing module can also filter radar point cloud data using a static point rule. Using the static point rule, the sensor data processing module can remove static points from the radar point cloud data using a map 306 that may include information about static objects in the real world. For example, the map 306 may include location or shape information about guardrails, trees, traffic lights, etc. In some embodiments, the sensor data processing module can determine a static point by determining that a velocity of an object in the radar point cloud is below a predetermined value. In some embodiments, the sensor data processing module can use the location information of the vehicle and the map 306 to determine static objects located around the vehicle and remove static radar point cloud data related to the static objects from the radar point cloud data.

In some embodiments, the sensor data processing module may filter radar point cloud data using any one or more of the following rules: a map based rule, a range related rule, a velocity rule, and a static point rule as explained in this patent document

After the sensor data processing module perform the filter related operations in operation 304, the sensor data processing module can obtain a filtered radar point cloud data. At operation 310, the sensor data processing module projects the filtered radar point cloud data onto three-dimensional (3D) IMU coordinate system using calibration data 312 such as the IMU-to-radar extrinsic parameters that may be previously determined. The IMU-to-radar extrinsic parameters can be related to the radar that sent the radar point cloud data to the sensor data processing module at operation 302, so that the sensor data processing module can use the IMU-to-radar extrinsic parameters that may describe the spatial relationships between the IMU and the radar that provided the radar point cloud data.

As shown in FIG. 3, at operation 310, the sensor data processing module may also obtain the LiDAR point cloud data 313 that includes information about one or more bounding boxes of one or more objects (e.g., vehicle and/or pedestrian) from the area that is scanned by a LiDAR, where the area may be same as or overlapping with the area scanned by the radar that sent the radar point cloud data at operation 302. A bounding box around an object may include a rectangular (or square/polygon) shaped box that is placed around an object located in the area. At operation 310, the sensor data processing module also projects the LiDAR point cloud data of the bounding box(es) of the object(s) onto the 3D IMU coordinate system using calibration data 312 such as the IMU-to-LiDAR extrinsic parameters that may be previously determined. The IMU-to-LiDAR extrinsic parameters can be related to the LiDAR that is associated with the LiDAR point cloud data of the bounding box(es) of the object(s), so that the sensor data processing module can use the IMU-to-LiDAR extrinsic parameters that may describe the spatial relationships between the IMU and the LiDAR that is associated with the LiDAR point cloud data of the bounding box(es) of the object(s). A technical benefit of projecting both filtered radar point cloud data and LiDAR point cloud data of the bounding box(es) of the object(s) onto the IMU coordinate system is that it can allow the sensor data processing module to combine or to relate radar point cloud data of an area to LiDAR point cloud data of a same or overlapping area. A technical benefit of using both LiDAR and radar point cloud data is that the sensor data processing module can process the radar point cloud data at or near the bounding box(es) of the object(s) provided by the LiDAR point cloud data to obtain position and/or velocity information of the object(s).

After the sensor data processing module projected the filtered radar point cloud data and the LiDAR point cloud data onto a same IMU coordinate system, at operation 314, the sensor data processing module can extract from the filtered radar point cloud data a subset of radar point cloud data that is associated with the bounding box(es) of the object(s). In an example implementation, the sensor data processing module can determine or obtain the subset of radar point cloud data is located on or within a predetermined distance of the bounding box(es) of the object(s). In some embodiments, the bounding box may extend by a certain length (e.g., 0.5 m) past the object.

At operation 316, the sensor data processing module can perform a data clustering technique on the subset of the radar point cloud data that is obtained at operation 314 based on the information related to the bounding box(es) for the object(s). An example of a data clustering technique may include a density-based spatial clustering of applications with noise (DB SCAN). The data clustering technique can allow the sensor data processing module to identify and group at least some of the subset of the radar point cloud data that are determined by the sensor data processing module to be related to the bounding box(es) based on the position(s) of the bounding box(es) obtained from the LiDAR point cloud data. For example, the data clustering technique performed by the sensor data processing module can remove a set of radar point cloud data from the subset of radar point cloud data upon determining that the set of radar point cloud data is not within or not on or not within a certain region/distance of the bounding box(es) of the object(s). After the sensor data processing module removes the set of radar point cloud data from the subset of radar point cloud data, the sensor data processing module may obtain a first set of clustered radar point cloud data that describes radar PCD associated with the bounding box(es) of the object(s).

At operation 316, the sensor data processing module can also cluster velocities of the first set of clustered radar point cloud data for each bounding box so that, for a bounding box, the sensor data processing module can remove certain velocities that may not be within a statistical range of the velocities indicated by at least some of the first set of clustered radar point cloud data for that bounding box. After the sensor data processing module removes from the first set of clustered radar point cloud data another set of radar point cloud data whose velocities are not within (or are outside of) the statistical range of velocities, at operation 318, the sensor data processing module may obtain the second set of clustered radar point cloud data as an output, where the second set of clustered radar point cloud data describe radar point cloud data of the bounding box(es) of the object(s) located in an environment where the vehicle is operated.

The first and/or second set of clustered radar point cloud data can provide the sensor data processing module with information about the object(s) in the bounding box(es). For example, the sensor data processing module can obtain velocity and location information of an object located in front of or to the rear of an autonomous vehicle (e.g., 105 in FIG. 1) using the first and/or second set of clustered radar point cloud data. Based on the first and/or second set of clustered radar point cloud data, the sensor data processing module can send instructions to the autonomous vehicle to perform certain autonomous driving related operations. For example, if the sensor data processing module determines, using the first and/or second set of clustered radar point cloud data, that a position of an object (e.g., truck) located in front of the autonomous vehicle is within a predetermined distance of the autonomous vehicle, then the sensor data processing module can send instructions to apply brakes and/or to steer the autonomous vehicle to another lane. In another example, if the sensor data processing module determines, using the first and/or second set of clustered radar point cloud data, that a velocity of car located to the rear left of the autonomous vehicle is greater than the speed of the autonomous vehicle and that the position of the car is within a certain distance (e.g., predetermined distance) of the location of the autonomous vehicle, then the sensor data processing module can determine not to change lane onto the left lane where the car is being driven.

FIG. 4 shows another flowchart of an example signal processing technique performed on radar point cloud data and LiDAR point cloud data for driving operations, such as autonomous driving operations. Operation 402 includes obtaining radar point cloud data of an area in an environment in which a vehicle is operating on a road, wherein the radar point cloud data is obtained or derived from a scan of the area by a radar located on the vehicle. Operation 404 includes obtaining filtered radar point cloud data by filtering the radar point cloud data using a set of one or more rules. Operation 406 includes obtaining a light detection and ranging point cloud data of at least some of the area scanned by a light detection and ranging sensor located on the vehicle, wherein the light detection and ranging point cloud data include information about a bounding box that surrounds an object on the road. Operation 408 includes determining a set of radar point cloud data that are associated with the bounding box that surrounds the object, wherein the set of radar point cloud data is determined from the filtered radar point cloud data that is combined with the light detection and ranging point cloud data onto a same coordinate system. Operation 410 includes causing the vehicle to operate based on one or more characteristics of the object determined from the set of radar point cloud data. Operations 402 to 410 can be performed by the sensor data processing module as explained in this patent document.

In some embodiments, the set of one or more rules includes a map based rule in which the filtered radar point cloud data is obtained by removing at least some radar point cloud data from the radar point cloud data in response to determining that the at least some radar point cloud data is not related to a road where the vehicle is operated. In some embodiments, the radar point cloud data is located on another road that is opposite to the road on which the vehicle is operated. In some embodiments, the set of one or more rules includes a range related rule in which the filtered of radar point cloud data is obtained by removing at least some radar point cloud data from the radar point cloud data in response to determining that the at least some radar point cloud data is located beyond a predetermined range of a location of the vehicle.

In some embodiments, the predetermined range is associated with the radar or is associated with a set of radars on the vehicle that includes the radar. In some embodiments, the set of one or more rules includes a velocity related rule in which the filtered radar point cloud data is obtained by removing at least some radar point cloud data from the radar point cloud data in response to determining that the at least some radar point cloud data is associated with one or more velocities that are outside of a predetermined range of velocities. In some embodiments, the one or more characteristics include a location and/or velocity of the object.

In some embodiments, the determining the set of radar point cloud data includes performing a data clustering technique using the filtered radar point cloud data that is combined with the light detection and ranging point cloud data onto the same coordinate system and the information about a position of the bounding box that surrounds the object, wherein the set of radar point cloud data includes information that describes the bounding box of the object. In some embodiments, the data clustering technique is performed by removing at least some radar point cloud data from the second set of radar that is combined with the light detection and ranging point cloud data in response to a determination that the at least some radar point cloud data is not within or not on or not within a certain region or distance of the bounding box of the object. In some embodiments, the data clustering technique includes a density-based spatial clustering of applications with noise technique. In some embodiments, the data clustering technique is performed by removing at least some radar point cloud data from the filtered radar point cloud data that is combined with the light detection and ranging point cloud data in response to a determination that the at least some radar point cloud data have one or more velocities that are outside of a statistical range of velocities.

In some embodiments, the causing the vehicle to operate based on the one or more characteristics of the object includes sending instructions to a steering system (e.g., a motor in the steering system) and/or to a brake system to steer and/or to apply brakes. In some embodiments, the causing the vehicle to operate based on the one or more characteristics of the object includes sending instructions that cause the vehicle to steer and/or to apply brakes. In some embodiments, the vehicle includes a plurality of radars that include the radar and a plurality of light detection and ranging sensors that include the light detection and ranging sensor, wherein at least one radar is located toward a front of the vehicle, wherein at least one radar is located on each side of the vehicle, and wherein at least one radar is located towards a rear of the vehicle.

In some embodiments, the set of one or more rules includes a velocity related rule in which the filtered radar point cloud data is obtained by removing at least some radar point cloud data from the radar point cloud data in response to determining that the at least some radar point cloud data is associated with at least one object whose velocity indicates that the at least one object is traveling towards the vehicle. In some embodiments, the set of one or more rules includes a static point rule in which the second set of radar PCT is obtained by removing at least some radar point cloud data from the radar point cloud data in response to determining that the at least some radar point cloud data is associated with static points using a map and a location of the vehicle. In some embodiments, the vehicle may include an autonomous vehicle.

In some embodiments, the filtered radar point cloud data is combined with the light detection and ranging point cloud data onto the same coordinate system by: projecting the filtered radar point cloud data onto an inertial measurement unit coordinate system using first extrinsic parameters; and projecting the light detection and ranging point cloud data onto the IMU coordinate system using second extrinsic parameters. In some embodiments, the first extrinsic parameters include an inertial measurement unit-to-radar extrinsic parameters, and wherein the second extrinsic parameters include an internal measurement unit-to-light detection and ranging extrinsic parameters. In some embodiments, the radar point cloud data, the filtered radar point cloud data, and the set of radar point cloud data include location information and/or velocity information of one or more objects in the area, wherein the one or more objects comprises the object. In some embodiments, the one or more objects include one or more vehicles and/or one or more pedestrians.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of vehicle operation, comprising:
obtaining radar point cloud data of an area in an environment in which a vehicle is operating on a road, wherein the radar point cloud data is obtained or derived from a scan of the area by a radar located on the vehicle;
obtaining filtered radar point cloud data by filtering the radar point cloud data using a set of one or more rules;
obtaining a light detection and ranging point cloud data of at least some of the area scanned by a light detection and ranging sensor located on the vehicle, wherein the light detection and ranging point cloud data include information about a bounding box that surrounds an object on the road;
determining a set of radar point cloud data that are associated with the bounding box that surrounds the object, wherein the set of radar point cloud data is determined from the filtered radar point cloud data that is combined with the light detection and ranging point cloud data onto a same coordinate system; and
causing the vehicle to operate based on one or more characteristics of the object determined from the set of radar point cloud data.

2. The method of claim 1, wherein the set of one or more rules includes a map based rule in which the filtered radar point cloud data is obtained by removing at least some radar point cloud data from the radar point cloud data in response to determining that the at least some radar point cloud data is not related to a road where the vehicle is operated.

3. The method of claim 2, wherein the radar point cloud data is located on another road that is opposite to the road on which the vehicle is operated.

4. The method of claim 1, wherein the set of one or more rules includes a range related rule in which the filtered of radar point cloud data is obtained by removing at least some radar point cloud data from the radar point cloud data in response to determining that the at least some radar point cloud data is located beyond a predetermined range of a location of the vehicle.

5. The method of claim 4, wherein the predetermined range is associated with the radar or is associated with a set of radars on the vehicle that includes the radar.

6. The method of claim 1, wherein the set of one or more rules includes a velocity related rule in which the filtered radar point cloud data is obtained by removing at least some radar point cloud data from the radar point cloud data in response to determining that the at least some radar point cloud data is associated with one or more velocities that are outside of a predetermined range of velocities.

7. The method of claim 1, wherein the one or more characteristics include a location and/or velocity of the object.

8. A system for vehicle operation, the system comprising a computer that comprises:
at least one processor and at least one memory including computer program code which, when executed by the at least one processor, cause the computer to at least:
obtain radar point cloud data of an area in an environment in which a vehicle is operating on a road, wherein the radar point cloud data is obtained or derived from a scan of the area by a radar located on the vehicle;
obtain filtered radar point cloud data by filtering the radar point cloud data using a set of one or more rules;
obtain a light detection and ranging point cloud data of at least some of the area scanned by a light detection and ranging sensor located on the vehicle, wherein the light detection and ranging point cloud data include information about a bounding box that surrounds an object on the road;
determine a set of radar point cloud data that are associated with the bounding box that surrounds the object, wherein the set of radar point cloud data is determined from the filtered radar point cloud data that is combined with the light detection and ranging point cloud data onto a same coordinate system; and
cause the vehicle to operate based on one or more characteristics of the object determined from the set of radar point cloud data

9. The system of claim 8, wherein to determine the set of radar point cloud data, the at least one memory further includes computer program instructions which, when executed by the at least one processor, further cause the computer to at least:
perform a data clustering technique using the filtered radar point cloud data that is combined with the light detection and ranging point cloud data onto the same coordinate system and the information about a position of the bounding box that surrounds the object, wherein the set of radar point cloud data includes information that describes the bounding box of the object.

10. The system of claim 9, wherein the data clustering technique is performed by the processor that upon execution is configured to remove at least some radar point cloud data from the second set of radar that is combined with the light detection and ranging point cloud data in response to a determination that the at least some radar point cloud data is not within or not on or not within a certain region or distance of the bounding box of the object.

11. The system of claim 9, wherein the data clustering technique includes a density-based spatial clustering of applications with noise technique.

12. The system of claim 9, wherein the data clustering technique is performed by the processor that upon execution is configured to remove at least some radar point cloud data from the filtered radar point cloud data that is combined with the light detection and ranging point cloud data in response to a determination that the at least some radar point cloud data have one or more velocities that are outside of a statistical range of velocities.

13. The system of claim 8, wherein to cause the vehicle to operate based on the one or more characteristics of the object, the at least one memory further includes computer program instructions which, when executed by the at least one processor, further cause the computer to at least:
send instructions that cause the vehicle to steer and/or to apply brakes.

14. The system of claim 8, wherein the vehicle includes a plurality of radars that include the radar and a plurality of light detection and ranging sensors that include the light detection and ranging sensor, wherein at least one radar is located toward a front of the vehicle, wherein at least one radar is located on each side of the vehicle, and wherein at least one radar is located towards a rear of the vehicle.

15. A non-transitory computer readable storage medium having code stored thereon, the code, when executed by a processor, causing the processor to implement a method comprising:
obtaining radar point cloud data of an area in an environment in which a vehicle is operating on a road, wherein the radar point cloud data is obtained or derived from a scan of the area by a radar located on the vehicle;
obtaining filtered radar point cloud data by filtering the radar point cloud data using a set of one or more rules;
obtaining a light detection and ranging point cloud data of at least some of the area scanned by a light detection and ranging sensor located on the vehicle, wherein the light detection and ranging point cloud data include information about a bounding box that surrounds an object on the road;
determining a set of radar point cloud data that are associated with the bounding box that surrounds the object, wherein the set of radar point cloud data is determined from the filtered radar point cloud data that is combined with the light detection and ranging point cloud data onto a same coordinate system; and
causing the vehicle to operate based on one or more characteristics of the object determined from the set of radar point cloud data.

16. The non-transitory computer readable storage medium of claim 15, wherein the set of one or more rules includes a velocity related rule in which the filtered radar point cloud data is obtained by removing at least some radar point cloud data from the radar point cloud data in response to determining that the at least some radar point cloud data is associated with at least one object whose velocity indicates that the at least one object is traveling towards the vehicle.

17. The non-transitory computer readable storage medium of claim 15, wherein the set of one or more rules includes a static point rule in which a second set of radar PCT is obtained by removing at least some radar point cloud data from the radar point cloud data in response to determining that the at least some radar point cloud data is associated with static points using a map and a location of the vehicle.

18. The non-transitory computer readable storage medium of claim 15, wherein the filtered radar point cloud data is combined with the light detection and ranging point cloud data onto the same coordinate system by:
projecting the filtered radar point cloud data onto an inertial measurement unit coordinate system using first extrinsic parameters; and
projecting the light detection and ranging point cloud data onto an inertial measurement unit (IMU) coordinate system using second extrinsic parameters.

19. The non-transitory computer readable storage medium of claim 15, wherein the radar point cloud data, the filtered radar point cloud data, and the set of radar point cloud data include location information and/or velocity information of one or more objects in the area, wherein the one or more objects comprises the object.

20. The non-transitory computer readable storage medium of claim 19, wherein the one or more objects include one or more vehicles and/or one or more pedestrians.
